(19) United States
(12) Patent Application Publication
(10) Pub. No.: US 2024/0190402 A1
(43) Pub. Date: Jun. 13, 2024

(54) AUTONOMOUS EMERGENCY BRAKING (AEB) WITH OCCUPANT STATES INPUT FOR AUTONOMOUS OR ASSISTED DRIVING VEHICLES

(71) Applicant: Apollo Autonomous Driving USA LLC, Sunnyvale, CA (US)

(72) Inventors: BAOPING YUAN, Sunnyvale, CA (US); YAOMING SHEN, Sunnyvale, CA (US); YIFEI JIANG, Sunnyvale, CA (US)

(21) Appl. No.: 18/065,330

(22) Filed: Dec. 13, 2022

(51) Int. Cl. B60T 7/22

(52) U.S. Cl. CPC B60T 7/22; B60T 2201/022; B60T 2210/32; B60T 2250/04

(57) ABSTRACT

This disclosure provides systems and methods for determining a rate of deceleration for automatic emergency braking (AEB) operations based, at least in part, on environment status including passenger status, road status, and the vehicle status itself, and providing a more comfortable passenger/occupancy feeling while maintaining autonomous drive safety as well when the AEB was engaged during Autonomous driving (AD). For example, based on a distance to an obstacle (or more obstacles, such as a vehicle behind) and a current velocity, a range of safe deceleration rates may be ascertained (e.g., to avoid impact against the vehicle in the front and allowing for spaces for the vehicle behind to decelerate). Within this range, a rate of deceleration is determined based on a status of the occupant of the vehicle, e.g., to avoid discomfort or even injury to the occupant.

### FIELD

Embodiments of the present disclosure relate generally to operating autonomous driving vehicles. More particularly, embodiments of the disclosure relate to braking systems and the controls.

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

AEB (autonomous emergency braking) may be engaged when a possible collision is detected or upon identifying a failure of an autonomous/assisted driving vehicle (ADV). An AEB system is capable of automatically decelerating the vehicle (often at a high rate of deceleration as allowable by the tires and/or the road conditions) for preventing car crashes, and/or reducing the impact if unavoidable. When determining the rate of deceleration, however, AEB systems often fail to consider occupant situations (e.g., the deceleration or related impact to be experienced by the occupants), as the AEB systems consider only external factors (e.g.; avoiding collisions with external objects). As such, the rate of deceleration may cause discomfort or injury to the occupants in the ADV.

### SUMMARY

The present disclosure provides methods, systems, and techniques for determining a rate of deceleration in an automatic emergency braking (AEB) system for an autonomous or assisted driving vehicle (ADV). In particular, the rate of deceleration is determined/selected based on physical and emotional impact to occupant(s) in the ADV. According to some aspects, the rate of deceleration may be selected in view of various conditions. For example, instead of calculating a deceleration value of AEB based on the distance of vehicles in front of and behind the ADV (e.g., using artificial intelligence), the present disclosure determines the final deceleration of the ADV without complex calculation and computing resources.

At a high level, the present disclosure provides a method that avoids complex copulation for deciding ADV deceleration value dynamically of AEB, while determining the ADV deceleration value rapidly and appropriately based on environment status, passenger status, and vehicle status, in order to provide a more comfortable passenger/occupancy feeling and autonomous drive safety as well. In other words, aspects of the present disclosure provide a method for determining dynamic/variable rates of deceleration of AEB based on the environment status that is critical to balance vehicle deceleration with safety and passenger/driver (collectively referred to as occupants herein) experiences. In addition, aspects of the present disclosure provide a method for smoothly switching the deceleration to achieve a more comfortable occupant feeling.

For example, the present disclosure uses a matrix of environment status including passenger status, road status, and vehicle itself status. With the matrix of environment status, the present disclosure determines a rate of AEB deceleration based on the distances of vehicle in the front and behind the ADV as well as road conditions. In some cases, the ADV may realize that a determined rate of deceleration exceeds a maximum threshold that the brake system may provide. In such cases, the ADV may prioritize lane changing and maneuver to avoid collision.

According to a first aspect, an embodiment of the disclosure provides a computer-implemented method for deceleration by a controlling device of an autonomous driving vehicle (ADV). The method includes measuring, based on a current velocity of the ADV, a time to impact from an obstacle in a course of a current trajectory of the ADV. The method includes measuring a physical state of an occupant carried by the ADV. The method includes computing, by a deceleration arbitration processing device, a rate of deceleration based on the time to impact and a physical change to the physical state of the occupant to be caused by the rate of deceleration. The method includes decelerating the ADV at the rate of deceleration.

According to a second aspect, an embodiment of the disclosure provides a data processing system of an ADV. The data processing system includes a processor; and a memory coupled to the processor to store instructions, which when executed by the processor, cause the processor to perform operations. The operations include measuring, based on a current velocity of the ADV, a time to impact from an obstacle in a course of a current trajectory of the ADV. The operations further include measuring a physical state of an occupant carried by the ADV. The operations include computing, by a deceleration arbitration processing device, a rate of deceleration based on the time to impact and a physical change to the physical state of the occupant to be caused by the rate of deceleration. The operations include decelerating the ADV at the rate of deceleration.

According to a third aspect, an embodiment of the disclosure provides a non-transitory machine-readable medium having instructions stored therein, which when executed by a processor, cause the processor to perform operations. The operations include: measuring, based on a current velocity of an ADV, a time to impact from an obstacle in a course of a current trajectory of the ADV; measuring a physical state of an occupant carried by the ADV; computing, by a deceleration arbitration processing device, a rate of deceleration based on the time to impact and a physical change to the physical state of the occupant to be caused by the rate of deceleration; and decelerating the ADV at the rate of deceleration.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system, in accordance with aspects of the present disclosure.

FIG. 2 is a block diagram illustrating an example of an autonomous/assisted driving (AD) vehicle, in accordance with aspects of the present disclosure.

FIG. 3 is a block diagram illustrating an example of an AD system for an autonomous driving vehicle, in accordance with aspects of the present disclosure.

FIG. 4 is a block diagram illustrating an example of a braking system, in accordance with aspects of the present disclosure.

FIG. 5 is a block diagram illustrating implementations of a primary braking system (PBS) and a secondary braking system (SBS), in accordance with aspects of the present disclosure.

FIG. 6 is a flow diagram 600 illustrating a method of providing an automatic emergency braking (AEB) procedure considering occupant states, in accordance with aspects of the present disclosure.

FIG. 7 is a diagram illustrating occupant states consideration for determining a deceleration for an AMB procedure, in accordance with aspects of the present disclosure.

FIG. 8 is a diagram illustrating steering consideration for determining a deceleration for an AMB procedure, in accordance with aspects of the present disclosure.

FIG. 9 illustrates bounds of deceleration, in accordance with aspects of the present disclosure.

FIG. 10 illustrates various braking thresholds, in accordance with aspects of the present disclosure.

FIG. 11 illustrates an example schematics of an AEB control system, in accordance with aspects of the present disclosure.

FIG. 12 illustrates an example algorithm with weight calibration for the AEB control system of FIG. 11, in accordance with aspects of the present disclosure.

FIG. 13 illustrates an example algorithm using machine learning for the AEB control system of FIG. 11, in accordance with aspects of the present disclosure.

FIG. 14 is a block diagram of an example AEB control system, in accordance with aspects of the present disclosure.

FIG. 15 a flow diagram illustrating a method of implementing an AEB, in accordance with aspects of the present disclosure.

FIG. 16 is a block diagram of an example control algorithm and the associated inputs and outputs, in accordance with aspects of the present disclosure.

Like reference numerals indicate like elements.

### DETAILED DESCRIPTION

Various embodiments and aspects of the disclosures will be described with reference to the details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, the present disclosure provides systems and methods for determining a rate of deceleration for automatic emergency braking (AEB) operations based, at least in part, on occupant status. For example, based on a distance to an obstacle (or more obstacles, such as a vehicle behind) and a current velocity, a range of safe deceleration may be ascertained (e.g., to avoid impact against the vehicle in the front and allowing for spaces for the vehicle behind to decelerate). Within this range, a rate of deceleration is determined based on a status of the occupant of the vehicle, e.g., to avoid discomfort or even injury to the occupant.

According to aspects of the present disclosure, a controller of an ADV may measure, based on a current velocity of the ADV, a time to impact from an obstacle in a course of a current trajectory of the ADV. The method includes measuring a physical state of an occupant carried by the ADV. The method includes computing, by a deceleration arbitration processing device, a rate of deceleration based on the time to impact and a physical change to the physical state of the occupant to be caused by the rate of deceleration. The method includes decelerating the ADV at the rate of deceleration for minimizing physical discomfort to be experienced by the occupants while providing a safety margin in view of surrounding obstacles.

For example, a computer-implemented method for deceleration by a controlling device of an ADV includes measuring, based on a current velocity of the ADV, a time to impact from an obstacle in a course of a current trajectory of the ADV. The method includes measuring a physical state of an occupant carried by the ADV. The method includes computing, by a deceleration arbitration processing device, a rate of deceleration based on the time to impact and a physical change to the physical state of the occupant to be caused by the rate of deceleration. The method includes decelerating the ADV at the rate of deceleration.

Unlike existing methods that compute a rate of deceleration using only external information (e.g., distances to surrounding obstacles), the present disclosure determines a deceleration request (DR) value balancing various factors, including occupant seat belt situations, positions, and vehicle orientations (affecting physical stress to the occupant), among others. These factors, in some embodiments, may be weighted and provided to an algorithm that arbitrates or selects a corresponding DR for the AEB system. In alternative embodiments, a machine learning model is trained to receive these factors and provide an output DR. The machine learning model may use training data set based on different riding situations and occupant feedbacks to use the occupant state as an input to determining the DR. This way, the present disclosure provides an AEB system that provides for safe braking while minimizing discomfort to be experienced by the occupant(s).

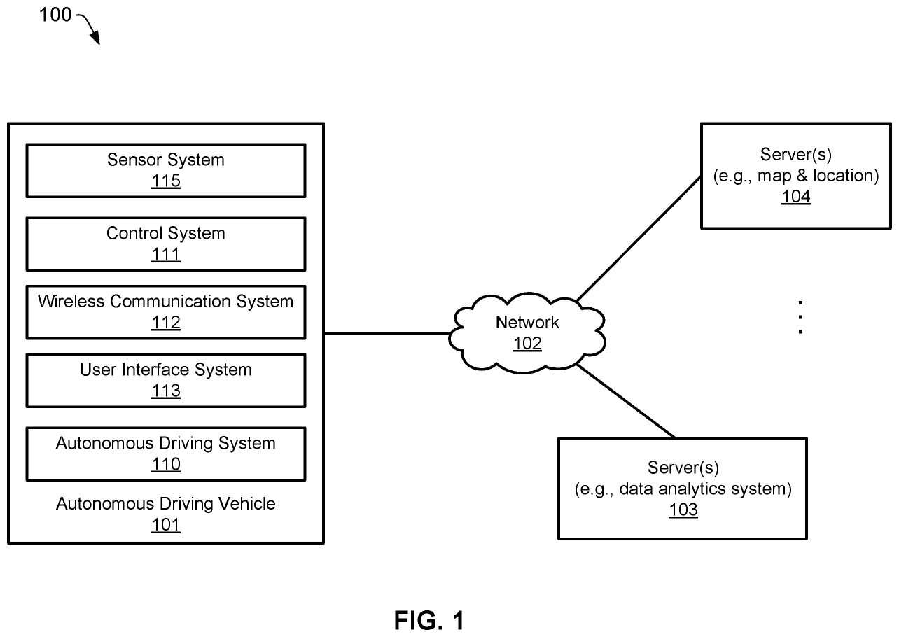

FIG. 1 is a block diagram illustrating an autonomous driving network configuration, in accordance with aspects of the present disclosure of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

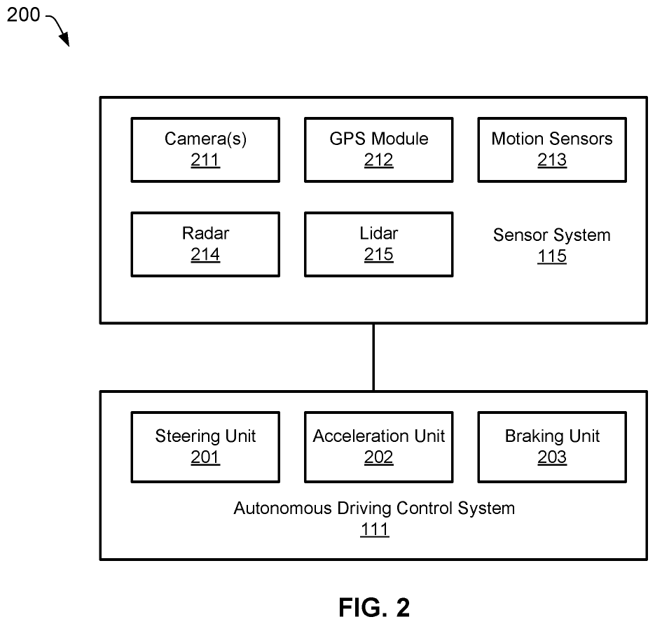

Referring now to FIG. 2, in one embodiment, sensor system 115 includes, but it is not limited to, one or more cameras 211, global positioning system (GPS) unit or module 212, motion sensors 213 (e.g., an inertial measurement unit (IMU), an accelerometer, etc.), radar unit 214, and a light detection and range (LIDAR) unit 215. The GPS module 212 may include a transceiver operable to provide information regarding the position of the ADV. The motion sensors 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

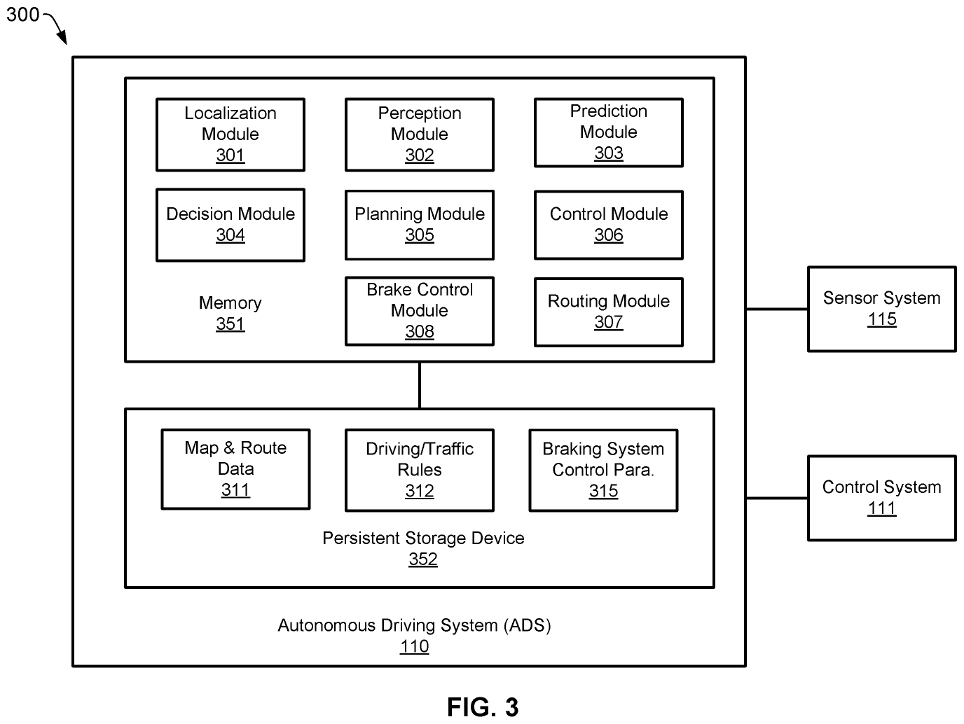

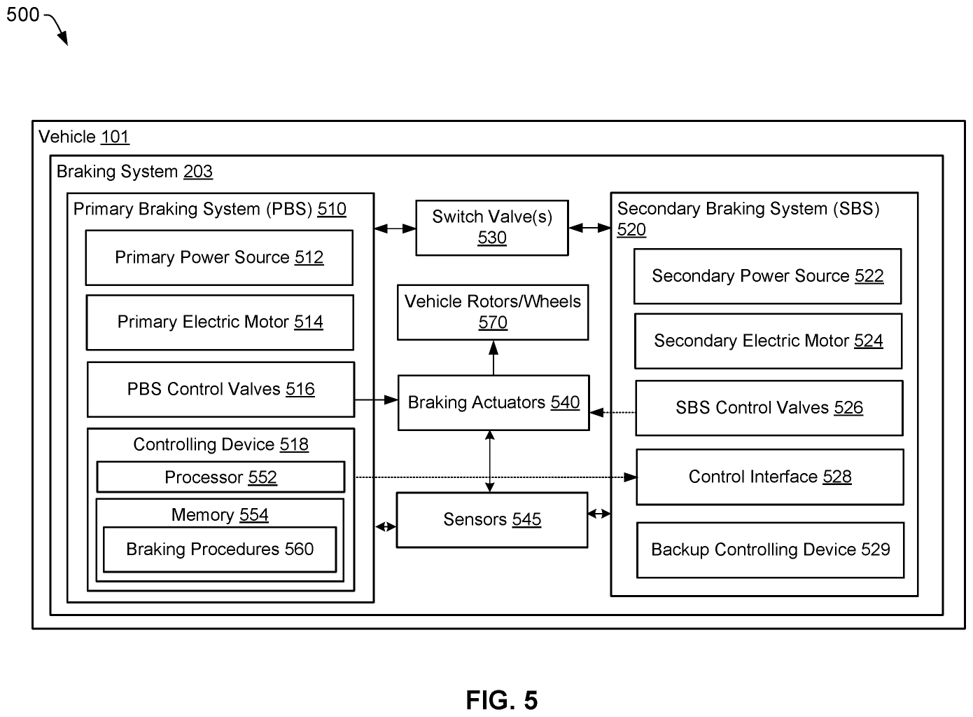

In one embodiment, vehicle control system 111 includes, but is not limited to, a steering unit 201, an acceleration unit 202, and a braking unit 203 (also referred to as the braking system 203). The steering unit 201 is to adjust the direction or heading of the vehicle. The acceleration unit 202 is to control the speed of the motor or engine that in turn controls the speed and acceleration of the vehicle. The steering unit 201 and the acceleration unit 202 may be coupled, in part, with the AD control 510 of FIG. 5. The braking unit 203 is to decelerate the vehicle by providing friction to slow the wheels or tires of the vehicle. The braking unit 203 may be coupled, in part, with the brake control module 308 of FIG. 3. As further discussed in FIG. 5, the braking unit 203 may include a primary braking system (PBS) 510 and a secondary braking system (SBS) 520, which is a redundant, backup braking system of the PBS. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

FIG. 3 is a block diagram illustrating an example of an AD system for an autonomous driving vehicle. The system 300 may be implemented as a part of ADV 101 of FIG. 1 including, but is not limited to, ADS 110, control system 111, and sensor system 115. Referring to FIG. 3, the ADS 110 includes, but is not limited to, a localization module 301, a perception module 302, a prediction module 303, a decision module 304, a planning module 305, a control module 306, a routing module 307, and a brake control module 308.

Some or all of modules 301-308 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-308 may be integrated together as an integrated module.

The localization module 301 determines a current location of the ADV 300 (e.g., leveraging GPS module 212) and manages any data related to a trip or route of a user. The localization module 301 (also referred to as a map and route module) manages any data related to a trip or route of a user. A user may log in and specify a starting location and a destination of a trip, for example, via a user interface. The localization module 301 communicates with other components of the ADV 300, such as map and route data 311, to obtain the trip related data. For example, the localization module 301 may obtain location and route data from a location server and a map and POI (MPOI) server. A location server provides location services and an MPOI server provides map services and the POIs of certain locations, which may be cached as part of map and route data 311. While the ADV 300 is moving along the route, the localization module 301 may also obtain real-time traffic information from a traffic information system or server.

Based on the sensor data provided by sensor system 115 and localization information obtained by the localization module 301, a perception of the surrounding environment is determined by the perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

The perception module 302 may include a computer vision system or functionalities of a computer vision system to process and analyze images captured by one or more cameras in order to identify objects and/or features in the environment of the ADV 300. The objects can include traffic signals, roadway boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. The perception module 302 can also detect objects based on other sensors data provided by other sensors such as a radar and/or LIDAR.

For each of the objects, the prediction module 303 predicts what the object will behave under the circumstances. The prediction is performed based on the perception data perceiving the driving environment at the point in time in view of a set of map/route information 311, traffic rules 312, and braking system control parameters 315. For example, if the object is a vehicle at an opposing direction and the current driving environment includes an intersection, the prediction module 303 will predict whether the vehicle will likely move straight forward or make a turn. If the perception data indicates that the intersection has no traffic light, the prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively. The prediction module 303 may calculate a rate of deceleration or stop distance based on the braking system control parameters 315 to determine a safe zone for driving at a desired speed. For example, some obstacles/vehicles or road conditions may cause the prediction module 303 to steer or decelerate to maintain the safe zone (e.g., clearance from other vehicles or obstacles). The braking control parameters 315 may include recorded deceleration data indicating an upper limit and/or environment correlated deceleration rates. In some cases, the braking system control parameters 315 may be used by both the PBS and the SBS.

For each of the objects, decision module 304 makes a decision regarding how to handle the object. For example, for a particular object (e.g., another vehicle in a crossing route) as well as its metadata describing the object (e.g., a speed, direction, turning angle), the decision module 304 decides how to encounter the object (e.g., overtake, yield, stop, pass). The decision module 304 may make such decisions according to a set of rules such as traffic rules or driving rules 312, which may be stored in the persistent storage device 352.

The routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. The routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line.

The topographic maps are then provided to the decision module 304 and/or planning module 305. The decision module 304 and/or planning module 305 may examine all of the possible routes to select and modify one of the most optimal routes in view of other data provided by other modules such as traffic conditions from the localization module 301, driving environment perceived by the perception module 302, and traffic condition predicted by the prediction module 303. The actual path or route for controlling the ADV may be close to or different from the reference line provided by the routing module 307 dependent upon the specific driving environment at the point in time.

Based on a decision for each of the objects perceived, the planning module 305 plans a path or route for the ADV, as well as driving parameters (e.g., distance, speed, and/or turning angle), using a reference line provided by the routing module 307 as a basis. That is, for a given object, the decision module 304 decides what to do with the object, while the planning module 305 determines how to do it. For example, for a given object, decision module 304 may decide to pass the object, while the planning module 305 may determine whether to pass on the left side or right side of the object. Planning and control data is generated by planning module 305 including information describing how the vehicle 101 would move in a next moving cycle (e.g., next route/path segment). For example, the planning and control data may instruct the vehicle 101 to move 10 meters at a speed of 30 miles per hour (mph), then to change to a right lane at the speed of 25 mph.

Based on the planning and control data, the control module 306 controls and drives the ADV, by sending proper commands or signals to the vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, the planning module 305 plans a next route segment or path segment, for example, including a target position and the time required for the ADV to reach the target position. Alternatively, the planning module 305 may further specify the specific speed, direction, and/or steering angle, etc. In one embodiment, the planning module 305 plans a route segment or path segment for the next predetermined period of time such as 5 seconds. For each planning cycle, the planning module 305 plans a target position for the current cycle (e.g., next 5 seconds) based on a target position planned in a previous cycle. The control module 306 then generates one or more control commands (e.g., throttle, brake, steering control commands) based on the planning and control data of the current cycle.

Note that the decision module 304 and the planning module 305 may be integrated as an integrated module. The decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via the user interface system 113. The navigation system may update the driving path dynamically while the ADV is in operation. The navigation system can incorporate data from a GPS system and one or more maps so as to determine the driving path for the ADV.

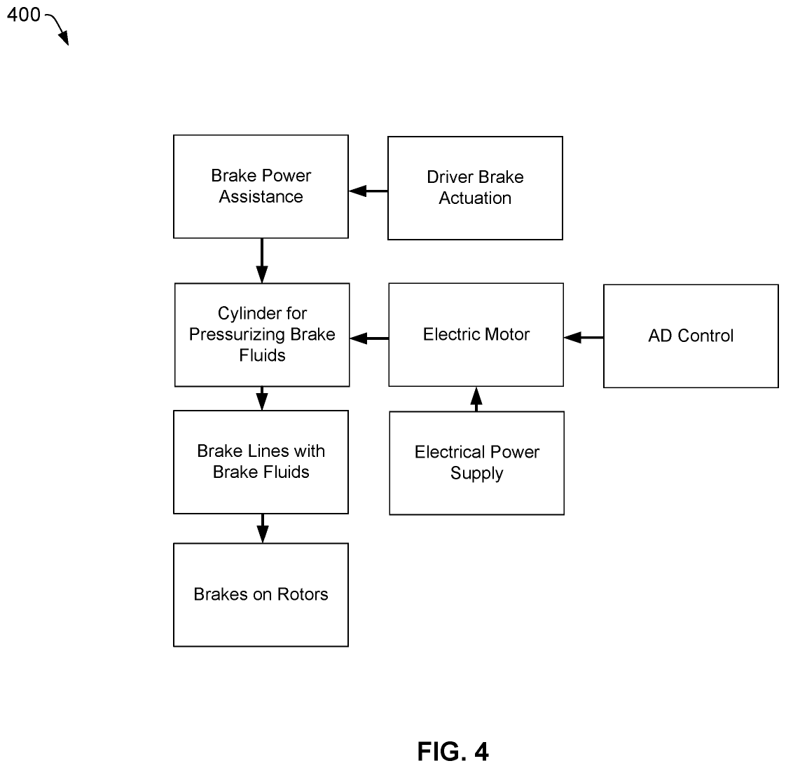

The brake control module 308 of FIG. 3 may be similar to (or functionally equivalent to) the brake control 520 of FIG. 5, in control of an example brake system 400 of FIG. 4. FIG. 4 is a block diagram illustrating an example of the braking system 400, in accordance with aspects of the present disclosure. As shown in FIG. 4, the braking system 400 includes at least a mechanism for receiving a braking actuation from a driver, a device for providing brake power assistance (e.g., a booster), a cylinder for pressurizing brake fluids, an electrical motor on the master cylinder, one or more brake lines with brake fluids for transmitting braking power to one or more brakes on rotors of the vehicle. The braking system 400 may also include an electrical power supply, independent from or shared with the vehicle. The braking system 400 may include or in connection with the AD control (such as the AD control 510 of FIG. 5) that operates on the mentioned components/devices with sensor feedbacks therefrom.

Although illustrated separately, the device providing brake power assistance and the electric motor on the master cylinder may be integrated into a common device. For example, the brake actuation by the driver may provide direct actuation to the electric motor on the master cylinder. In other embodiments, the brake power assistance device may be a separate or independent (e.g., hydraulic) system to provide secondary control of the master cylinder, such as for emergency engagement by the driver when AD control does not operate as intended. As discussed herein, the brake control module 308 may reduce the power consumption by the electric motor on the master cylinder to conserve energy when the vehicle performs a traffic stop on a slope or gradient.

FIG. 5 is a block diagram 500 illustrating implementations of a primary braking system (PBS) 510 and a secondary braking system (SBS) 520, in accordance with aspects of the present disclosure. As shown, the ADV 101 includes the braking system 203, which includes the PBS 510 and the SBS 520. The braking system 203 also includes a number of switch valves 530 operable to switch between the PBS 510 and the SBS 520. The braking system 203 includes a number of braking actuators 540, each braking actuator 540 operable to apply a braking pressure on a rotor or wheel 570 of the ADV 101 to generate frictional forces to decelerate or stop the rotation thereof. The braking system 203 includes a number of sensors 545 for monitoring the operating conditions of the PBS 510, the SBS 520, the braking actuators 540, and other aspects of the braking system 203 and the vehicle 101 (e.g., rotations o the rotors or wheels 570, the switch valves 530, the orientations and rotations of the vehicle 101, etc.).

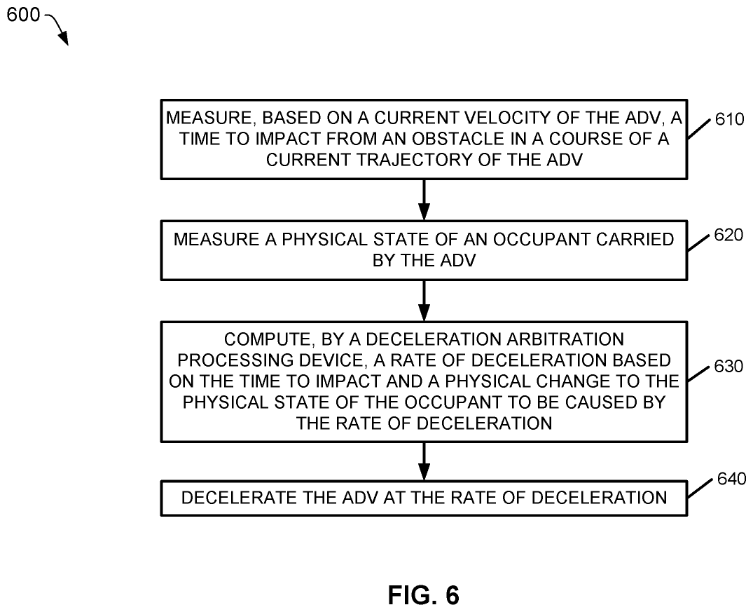

The PBS 510 may be powered by a primary power source 512. The PBS 510 may include a primary electric motor 514 to generate a primary pressure (e.g., hydraulic or pneumatic) to provide hydraulic or pneumatic power to the braking actuators 540. The PBS 510 includes a number of PBS control valves that receives the hydraulic or pneumatic power and operable to vary respective actuating braking pressures at the braking actuators 540. The PBS 510 includes a controlling device 518 to operate the PBS control valves 516 for varying the respective actuating braking pressures at the braking actuators 540 during different braking procedures. For example, the controlling device 518 controls the braking actuators 540 to independently perform primary braking procedures including at least: (1) a primary longitudinal control, (2) a primary stability control, and (3) a primary standstill control (as further discussed in FIG. 6 below). The sensors 545 monitors the primary braking procedures and detects when the braking procedure and/or a related component malfunctions.

The braking system 203 includes at least one switch valve 530 configured to switch the PBS 510 to the SBS 520 upon detecting, by the controlling device 518 via the sensors 545, that at least one of the primary braking procedures is malfunctioning. The controlling device 518 may include a processor 552 and a non-transitory memory 554 coupled to the processor 552. The memory 554 may include instructions for the controlling device 518 to cause the PBS 510 or the SBS 520 to perform braking procedures 560 (e.g., primary braking procedures and backup/secondary braking procedures, as discussed in FIG. 6).

As shown in FIG. 5, the SBS 520 is independent from the PBS 510 and includes a secondary power source 522 and a secondary electric motor 524. The secondary electric motor 524 is independent from the primary electric motor 514. The SBS 520 includes a number of SBS control valves 526, which is configured to operate the braking actuators 540. For example, the SBS 520 may use the secondary electric motor 524 to generate a second pressure providing the hydraulic power. The SBS 520 switches at least one switch valve 530 to operate the braking actuators 540. As such, the SBS 520 may control the braking actuators 540 independent from the PBS 510.

In some embodiments, the SBS control valves 526 are controlled by the controlling device 518 and are operable to independently provide backup braking procedures at the braking actuators 540. The SBS 520 may also include a backup controlling device 529 to perform the braking control procedures in case the controlling device 518 fails. The SBS 520 may include a control interface 528 for the controlling device 518 to engage various components (e.g., the SBS control valves 526) of the SBS 520. In some cases, the control interface 528 may allow the backup controlling device 529 to synchronize control parameters with the controlling device 518. When the SBS 520 is engaged, the controlling device 518 may cause the SBS 520 to perform backup braking procedures correspond to the malfunctioning at least one of the primary braking procedures.

In some cases, the memory 554 coupled to the processor 552 stores instructions that are executable by the processor 552. The instructions, when executed, may cause the processor 552 to receive data of obstacle conditions and road conditions. When conditions for braking is detected or satisfied, the processor 552 may disengage a power supply to one or more motors of the vehicle 101 based on the data of obstacle conditions and road conditions. The one or more motors may include at least one electric motor or an internal combustion engine. The processor 552 may then engage the first braking sub-system of the braking system to perform one or more of the primary braking procedures by default. Upon detecting that that at least one of the primary braking procedures is malfunctioning by the controlling device 518 via the sensors 545, the controlling device 518 engages the SBS 520 to provide for a backup braking procedure corresponding to the malfunctioning primary braking procedure.

As shown in FIG. 5, the PBS control valves 516 and the SBS control valves 526 may respectively and independently control each of the braking actuators 540. Each of the braking actuators 540 respectively provides braking forces on each rotor or wheel 570 of the ADV 101. In some cases, the processor 552 and the memory 554 of the controlling device 518 are further to receive sensor data of rotation of each wheel of the ADV 101, and individually control, via the SBS control valves 526 each of the braking actuators 540 to perform various braking procedures. For example, the SBS 520 increases, in a secondary longitudinal control (e.g., AEB), a braking pressure when an emergency condition has been detected (e.g., imminent impact). The backup controlling device 529 may include a similar processor and memory as the processor 552 and the memory 554 of the controlling device 518 to provide backup braking procedures in case the controlling device 518 malfunctions.

In some cases, the SBS 520 may increase, in the secondary longitudinal control (e.g., ACC), the braking pressure to slow down the ADV 101 when a speed difference between the computer assisted driving vehicle and one or more surrounding vehicles exceeds a threshold value (e.g., due to downhill accelerations).

In some cases, the SBS 520 may reduce, in a secondary stability control (e.g., ABS), a braking pressure (e.g., via one of the braking actuators 540) on at least one wheel 570 when the at least one wheel 570 rotates slower than other wheels to indicate locking, as measured by one of the sensors 545.

In some cases, the SBS 520 increases, in the secondary stability control (e.g., ESC), a braking pressure on at least one wheel when a difference between a desired steering direction and a measured steering direction exceeds a threshold value (e.g., understeering or oversteering).

In some cases, the SBS 520 engages, in a secondary standstill control (e.g., HAS), a parking brake when an unintended wheel rotation has been detected. The parking brake applies a braking force for holding the ADV 101 still.

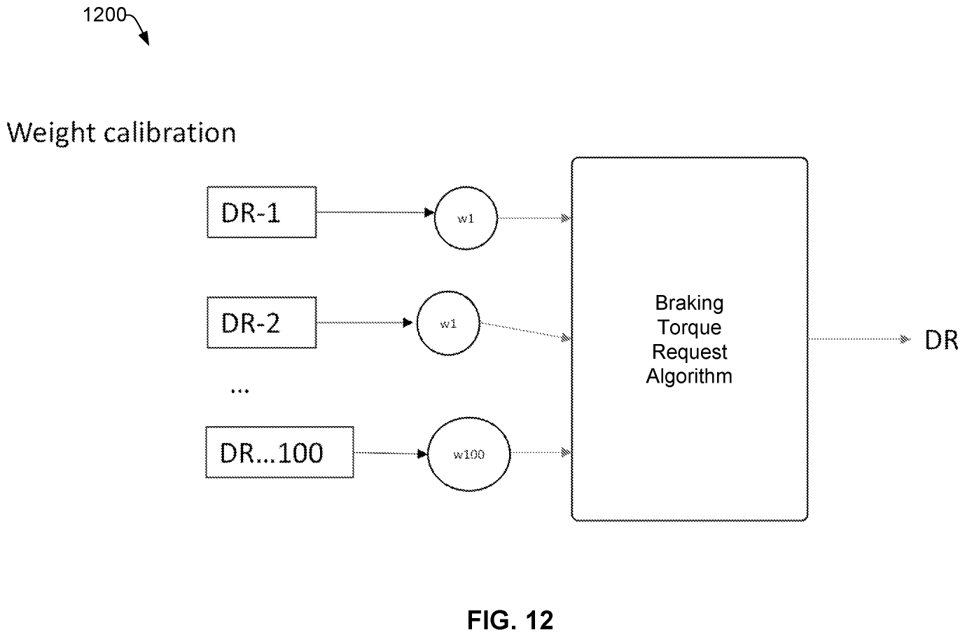

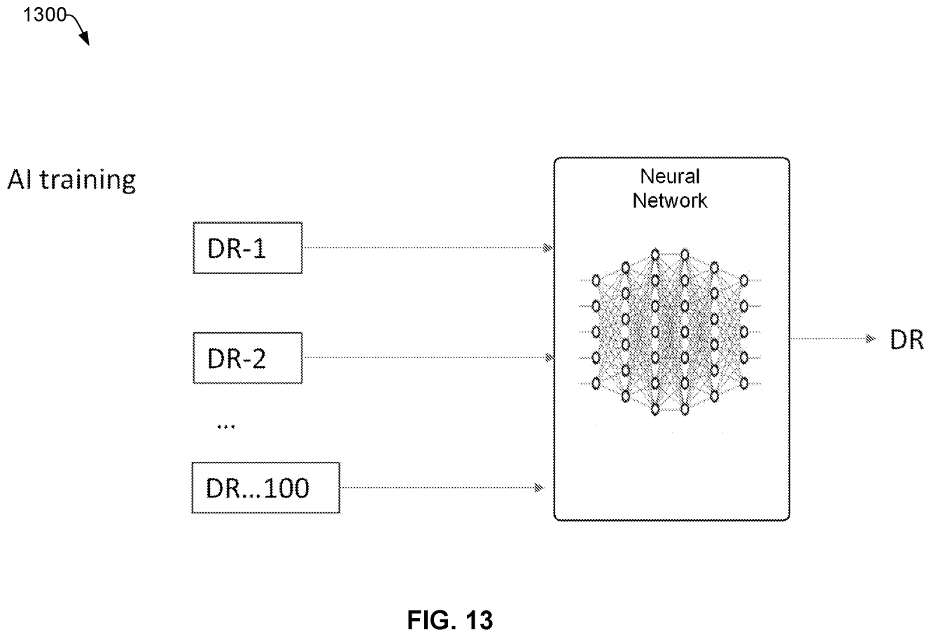

In aspects, the switch valves 530 may include (as further shown in FIGS. 12-13) a first actuation valve operable to separate the second braking sub-system from the first braking sub-system that comprises a master cylinder, when the second braking sub-system is engaged upon detecting, by the controlling device via the plurality of sensors, that at least one of the primary braking procedures is malfunctioning. The first actuation valve prevents the first pressure to apply to the second braking sub-system by switching from a primary position to a secondary position. For example, in the primary position, the first actuation valve provides hydraulic fluids from a master cylinder and a booster cylinder to the first plurality of valves; and in the secondary position, the first actuation valve shuts off hydraulic fluids from the master cylinder.

In some cases, the at least one switch valve 530 further includes a second actuation valve operable to switch between a free-flow position and a check valve position. The free-flow position is used during engagement of the second braking sub-system for receiving hydraulic fluids from the booster cylinder.

In aspects, the braking actuators 540 include a front-left braking actuator operable to apply a braking force on a front-left wheel of the computer assisted driving vehicle; a front-right braking actuator operable to apply a braking force on a front-right wheel of the computer assisted driving vehicle; a rear-left braking actuator operable to apply a braking force on a rear-left wheel of the computer assisted driving vehicle; and a rear-right braking actuator operable to apply a braking force on a rear-right wheel of the computer assisted driving vehicle. The PBS control valves 516 and the SBS control valves 526 are respectively operable to independently vary corresponding braking forces on the front-left, front-right, rear-left, and rear-right wheels. In some cases, the rear-left braking actuator and the rear-right braking actuator further include an electronic parking brake (EPB) respectively or jointly. For example, the EPB may be actuated to apply a braking pressure without continuous consumption of electricity.

FIG. 6 is a flow diagram 600 illustrating a method of determining a rate of deceleration in an AEB system for an ADV, in accordance with aspects of the present disclosure. The method may be applicable to electric, hybrid, or internal combustion engine powered ADVs. The method may be performed by a processing logic (e.g., the ADS 110 of FIG. 3), which may include software, hardware, or a combination thereof. As an example, the method illustrated in the flow diagram 600 may be performed by the control module 306 of FIG. 3. In some cases, the control module is a deceleration arbitration processing device. For example, when different rates of decelerations are suggested based on conditions of various aspects, the deceleration arbitration processing device arbitrates a final deceleration request value, such as by using a weighted algorithm or a machine learning model.

At operation 610, the control module measures, based on a current velocity of the ADV, a time to impact from an obstacle in a course of a current trajectory of the ADV. For example, the control module may receive sensor data (e.g., from computer vision or LIDAR measurements) regarding an object in front of or after the ADV. For example, the object may be a vehicle, roadblock, or a pedestrian in front of the ADV, or a vehicle behind the ADV. The time to impact may be determined based on the relative velocities (e.g., variable by deceleration) between the ADV and the object and based on the distance between the ADV and the object. In some cases, the time to impact includes both the time to impact the object in the front of the ADV and the time to impact by another object following the ADV.

In some cases, the time to impact is detected or triggered due to a failure of the ADV. For example, when there is a power failure or steering failure, the control module may determine a rate of deceleration to safely avoid collision with surrounding objects, such as a vehicle following behind. Table 1 presents some failure classes that may trigger the AEB.

TABLE 1
Example Failure Classes

| Failure classification | Name |
|---|---|
| Failure class -1: | Entertains messages |
| Failure class -2: | Sensors . . . |
| Failure class -3: | Powertrain systems |
| Failure class -4: | Steering systems |
| Failure class -5: | Computer commands class-1 |
| Failure class -6: | Computer commands class-2 |
| Failure class -7: | Brake systems |
| . . . | . . . |

At operation 620, the control module, measures a physical state of an occupant (e.g., a passenger or a driver who may provide input to the ADV) carried by the ADV. For example, the control module may receive measurement data or signals that monitor, with at least an optical sensor, an infrared sensor, or a strain sensor, a constraint condition of the occupant. In some cases, the optical sensor may monitor (e.g., by computer vision) a seatbelt condition and a seating position of the occupant, such as whether the occupant has a seatbelt fastened correctly (including checking the locking mechanism as well as there the seatbelt is constraining relative to the body of the occupant), and whether the seating position provides normal forces in certain directions (e.g., an inclined seating position may have reduced support in the longitudinal direction of the ADV and may reduce the constraining forces provided by the seatbelt).

In addition, the infrared sensor may also monitor, via temperature information, the seatbelt condition, and the seating position of the occupant (e.g., using infrared computer vision to determine the occupant's size, posture, and relative position to the seat based on temperature differences). Furthermore, the strain sensor may measure a stress level of the seatbelt condition (e.g., to determine how tight, or any pre-tension, the seatbelt is due to different habits of wearing seatbelts). Based on the monitored information, the control module may then determine an estimate of a body mass of the occupant via the optical sensor, the seatbelt condition, or both. For example, the body mass may be determined by a size estimate from the computer vision measurements (e.g., using an estimated volume and a reference human density). The estimated body mass may later be used to determine the forces the occupant will experience at various rates of decelerations.

In some cases, the physical state of the occupant may be quantized using various weighted values (or weighting factors), as the ones shown in Table 2 below. The AEB system may be pre-calibrated with different DR values corresponding to each occupant state category. For example, the rates of decelerations are different in view of the occupants including adults, children, or infants, as well as whether the occupants are wearing seatbelts and the seating positions (e.g., front or back seat, as the back seating position may use the support from the back of a front seat). The listed categories in Table 2 need not exclude one another and may all be considered in a final rate of deceleration (e.g., weighted or arbitrated by a machine learning model), as discussed below.

TABLE 2
Example Occupant States and Associated Deceleration Requests (DRs)

| | Deceleration | | Rate of | | | | |
|---|---|---|---|---|---|---|---|
| | Request (DR) | Weighting | Deceleration | Safety Features | Deceleration | | Deceleration |
| Occupants States | (e.g., in m/s\hat{ }2) | factors | (m/s\hat{ }2) | or Limitations | Spec (m/s\hat{ }2) | Vehicle Status Limitations | Spec (m/s\hat{ }2) |
| Passenger positions | DR-1 | w1 | DR-1 * w1 | Distance by | DC-1 | Vehicle brake low threshold | DC-1 |
| | | | | front vehicle | | for braking system | |
| Passenger belt | DR-2 | w2 | . . . | Distance by | DC-2 | Vehicle brake threshold of | DC-2 |
| | | | | Rear vehicle | | braking system | |
| Children Present | DR-3 | w3 | . . . | High u | DV-1 | Vehicle brake low threshold of | DC-3 |
| | | | | | | vehicle regeneration braking | |
| Infant Present | DR-4 | w4 | . . . | Middle u | DV-1 | Vehicle brake up threshold of | DC-4 |
| | | | | | | vehicle regeneration braking | |
| Elderly Present | DR-5 | w5 | . . . | Low u | DV-3 | | |
| Positive slop | DR-6 | w6 | . . . | Ice road . . . | DV-4 | | |
| Negative slop | DR-7 | w7 | . . . | | | | |
| Vehicle types | DR-8 | w8 | | | | | |
| Failure class -1 | DR-9 | w9 | | | | | |
| Failure class -2 | Dr-10 | w10 | | | | | |
| Failure class -3 | . . . | . . . | | | | | |

At operation 630, the control module computes, a rate of deceleration based on the time to impact and a physical change to the physical state of the occupant to be caused by the rate of deceleration. For example, the control module may compare the rate of deceleration with a control limit. The control limit may be identified based on the braking power of the braking system of the ADV, the tire properties, the road conditions, and movement information of surrounding vehicles or objects. For example, the control limit provides information of a minimal rate of deceleration to avoid collision with the object in the front and a maximal rate of deceleration achievable by the braking system of the ADV (and in view of potential collision with the vehicle behind).

In some aspects, the maximal rate of deceleration may correspond to an upper bound of value corresponding to a maximal magnitude of deceleration generated by a braking system of the ADV. For example, the braking system may include a contact surface (e.g., of the tires) engaging the current trajectory (e.g., the current road) and a braking mechanism converting a kinetic energy of the ADV into a non-kinetic energy of the ADV. In some cases, the non-kinetic energy includes at least one of: a thermal energy or an electric energy.

In response to the rate of deceleration exceeding the control limit (e.g., below the minimal or above the maximal rates of deceleration), the control module may update the rate of deceleration to a limited rate of deceleration. The limited rate of deceleration takes the minimal and maximal rates of accelerations into consideration.

At operation 640, the control module decelerates the ADV at the rate of deceleration computed above. For example, the control module applies a requested deceleration to the braking system to prevent collision as well as to minimize discomfort to the occupant. In some cases, the deceleration procedure may include steering (e.g., changing to a different lane) to achieve a rate of deceleration within the control limit as well as avoiding substantial discomfort to the occupants in the ADV.

In aspects, the control module may compute the rate of deceleration based on the time to impact and the physical change to the physical state of the occupant by minimizing a peak physical stress of the physical change associated with the rate of deceleration. The peak physical stress is modeled based on a constraint condition of the occupant, such as a concentrated stress at certain points of seatbelt generating high pressure during emergency braking.

In aspects, the control module may compare a peak physical stress to a comfort stress value associated with the body mass and seatbelt condition of the occupant; and in response to the peak physical stress exceeding the comfort stress value, reduce the rate of deceleration to reduce the peak physical stress to the comfort stress value.

In some cases, the control module determines that the reduced rate of deceleration does not provide a safe operation of the ADV in the current trajectory. The control module identifies an alternative trajectory of safe operation that provides the reduced rate of deceleration. In some cases, the alternative trajectory of safe operation includes a different traveling lane adjacent to the current trajectory.

In aspects, the control module decelerates the ADV at the rate of deceleration by decelerating the ADV using a primary braking system (PBS) by implementing a brake torque request algorithm executing the rate of deceleration; and in response to detecting a malfunction of the PBS, decelerating the ADV using a secondary braking system (SBS) by implementing the brake torque request algorithm executing the rate of deceleration.

In aspects, the control module computes, by the deceleration arbitration processing device, the rate of deceleration by training a machine learning model (e.g., as shown in FIG. 13) at the deceleration arbitration processing device with experimental and simulation data of occupant feedback and physical stress measurements to predict a relationship between the rate of deceleration and one or more of: seating configuration, seatbelt configuration, body mass of the occupant, and a comfort stress range indicated by the occupant feedback.

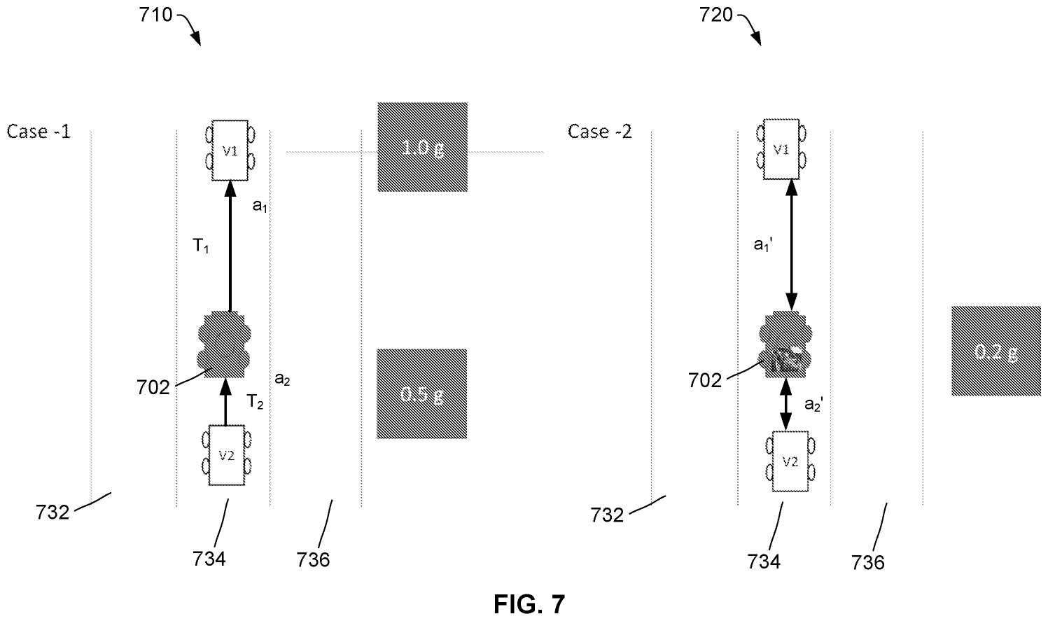

FIG. 7 is a diagram illustrating occupant states consideration for determining a deceleration for an AMB procedure, in accordance with aspects of the present disclosure. Two scenarios 710 and 720 are illustrated. As shown in the example scenario 710, an ADV 702 is traveling in a trajectory (e.g., a straight line) along the lane 734. A first vehicle V1 is traveling in front of the ADV 702. A second vehicle V2 is traveling behind the ADV 702. The first vehicle V1 may suddenly decelerate (e.g., at −1.0 g) due to traffic ahead. The ADV 702 may measure, based on its current traveling velocity and the velocity differences, a time to impact from V1 (e.g., T₁) or V2 (e.g., T₂). V2 may decelerate with a delayed onset in response to the deceleration of the ADV 702. In the scenario 710, the ADV 702 may calculate the rate of deceleration (e.g., −0.5 g) that avoids collisions with V1 or V2 without considerations of the occupants therein. The relative rate of deceleration to V1 may be a₁ and the relative rate of deceleration to V2 may be a₂.

By comparison, in scenario 720, in addition to determining the rate of deceleration based on the time to impact from V1 or V2, the ADV 702 may further measure a physical state of an occupant carried by the ADV 702. For example, the ADV 702 may use cabin cameras, infrared sensors, and strain-gauges to collect information regarding the occupant states, such as whether booster seats are installed, seatbelts are fastened, and other constraint conditions of the occupant. As shown in FIG. 7, the ADV 702 has detected a booster seat and a presence of a child or infant, and detected that (e.g., by computer vision) the booster seat has been installed in a correct direction and has secured to the car seats. As such, the ADV 702 considers only a discomfort level for the child or infant (e.g., without further considering potential dislocation of the booster seat or impact to be caused by the deceleration). The ADV 702 computes an updated rate of deceleration a₁′ (e.g., −0.2 g) that satisfies a safety criterion as to avoiding impact with V1 while reducing the associated occupant discomfort caused by the deceleration.

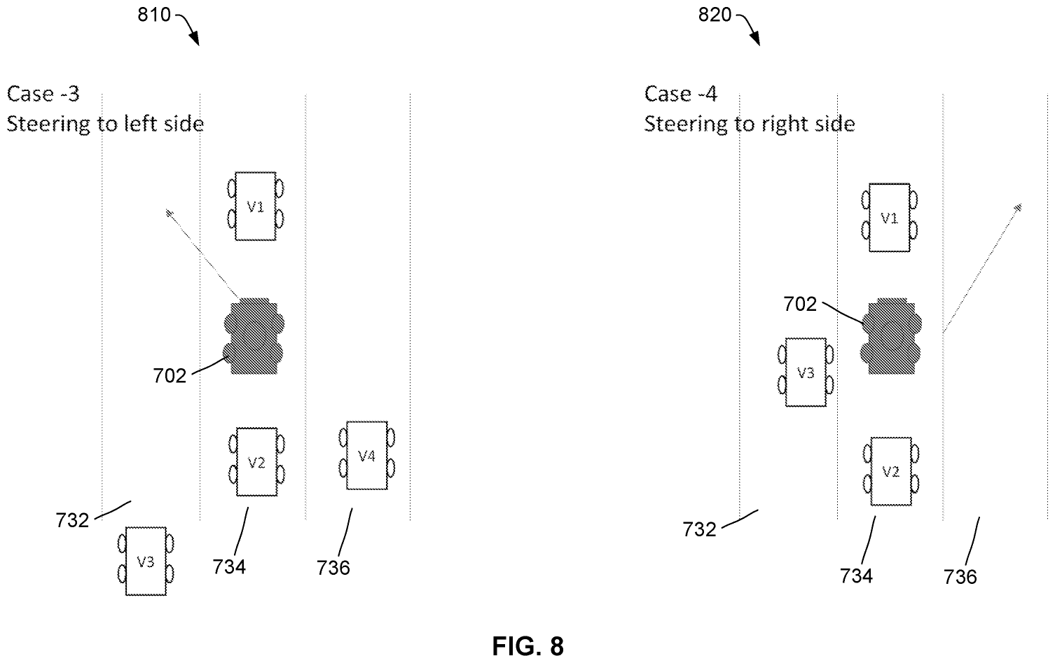

FIG. 8 is a diagram illustrating steering consideration for determining a deceleration for an AMB procedure, in accordance with aspects of the present disclosure. Two scenarios 810 and 820 are illustrated for situations where the ADV 702 determines that engaging the AEB in the same lane 734 would cause harm or significant discomfort to the occupant. For example, when the occupant is not properly constrained by seatbelt or car seat, a rate of deceleration that avoids impact with V1 and V2 would cause pain or injury to the occupant. In such situations, the ADV 702 seeks steering options to avoid impact while avoiding disturbance to the occupant state. As shown in the scenario 810, the ADV 702 identifies that more spaces (e.g., V3 is further behind than V4) and maneuver time are available in the left lane 732 than those available in the right lane 736 and decides to change to the left lane 732. In scenario 820, the ADV 702 identifies that more spaces and maneuver time are available in the right lane 736 than those available in the left lane 732 (e.g., V3 partially blocks the lane 732). The ADV 702 decides to change to the right lane 736.

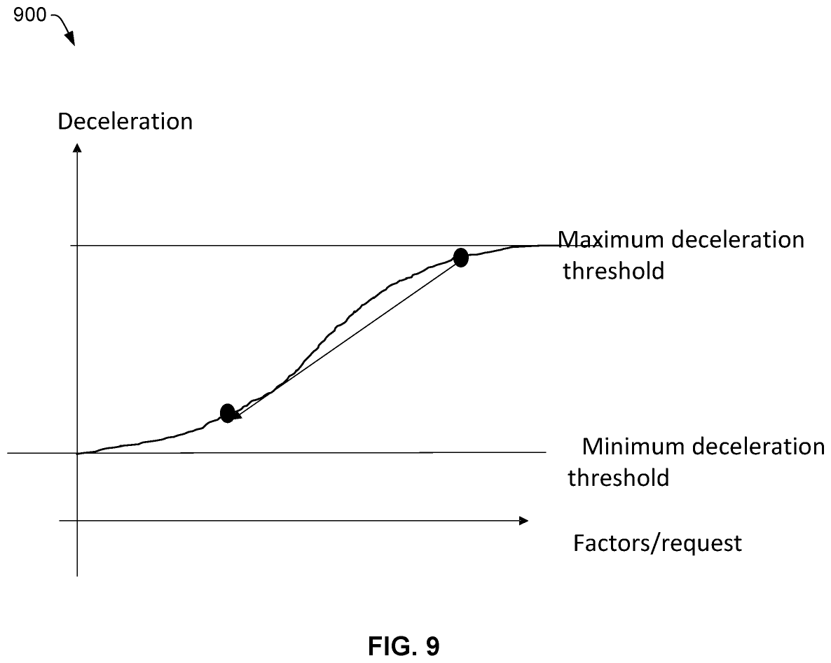

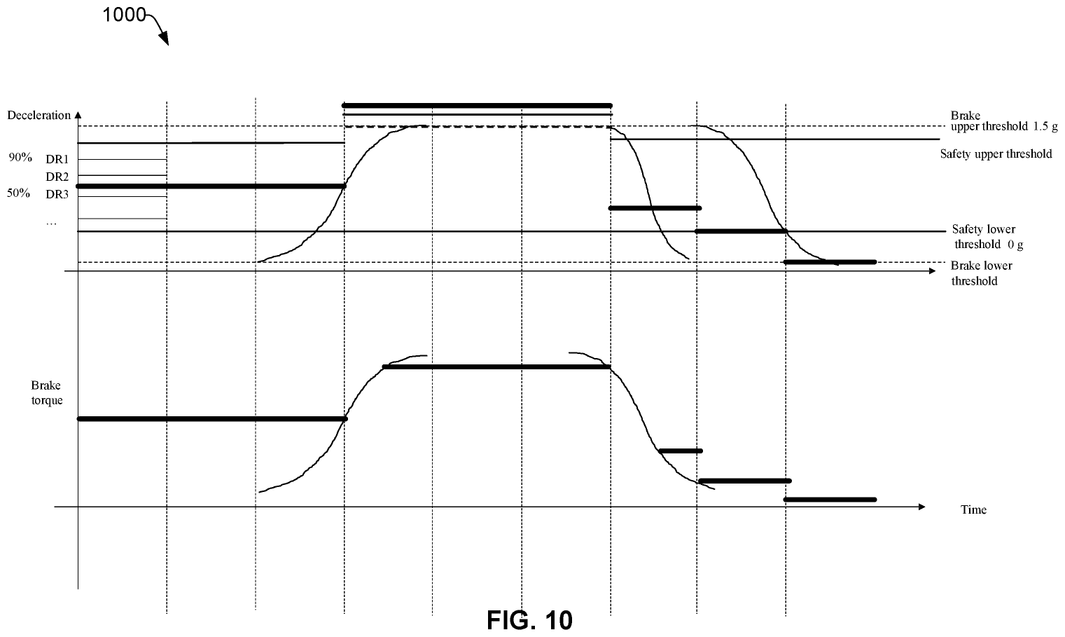

FIG. 9 illustrates bounds 900 of deceleration, in accordance with aspects of the present disclosure. As discussed with respect to FIG. 6, when AEB is engaged, the rate of deceleration is often bounded by physical limitations (e.g., the upper bound or maximum deceleration threshold) and safety limitations. As shown, the horizontal axis represents a number of factors to be considered and the associated requests. The vertical axis represents a variable rate of deceleration, which is bounded by a maximum deceleration threshold and a minimum deceleration threshold. The maximum deceleration threshold corresponds to a physical limit by the braking system, the tire, and the road conditions, and may be updated based on current measurements. The minimum deceleration threshold corresponds to an impact limit in view of surrounding objects (e.g., the lowest rate of deceleration that results the ADV to be in contact with a surrounding object at zero relative speed). Within the range, the ADV's control module may determine or select a rate of deceleration that minimizes discomfort to the occupants of the ADV, as further discussed in FIG. 10.

FIG. 10 illustrates various braking thresholds 1000, in accordance with aspects of the present disclosure. As shown, the selectable rates of decelerations are bounded by the upper threshold and the lower threshold (respectively corresponding to the maximum and minimum deceleration thresholds of FIG. 9). The control module of the ADV may apply a safety factor to the upper and lower thresholds, resulting in a safety upper threshold and a safety lower threshold. Various deceleration requests may be made (see Table 2 above) in view of occupant states. The DR factors may increase or decrease the rate of deceleration under specific circumstances, to ensure both safety and comfort levels of the occupants in the ADV. Correspondingly, the control module may compute requests of the braking torque to execute the rate of deceleration, as shown in the torque request diagram below.

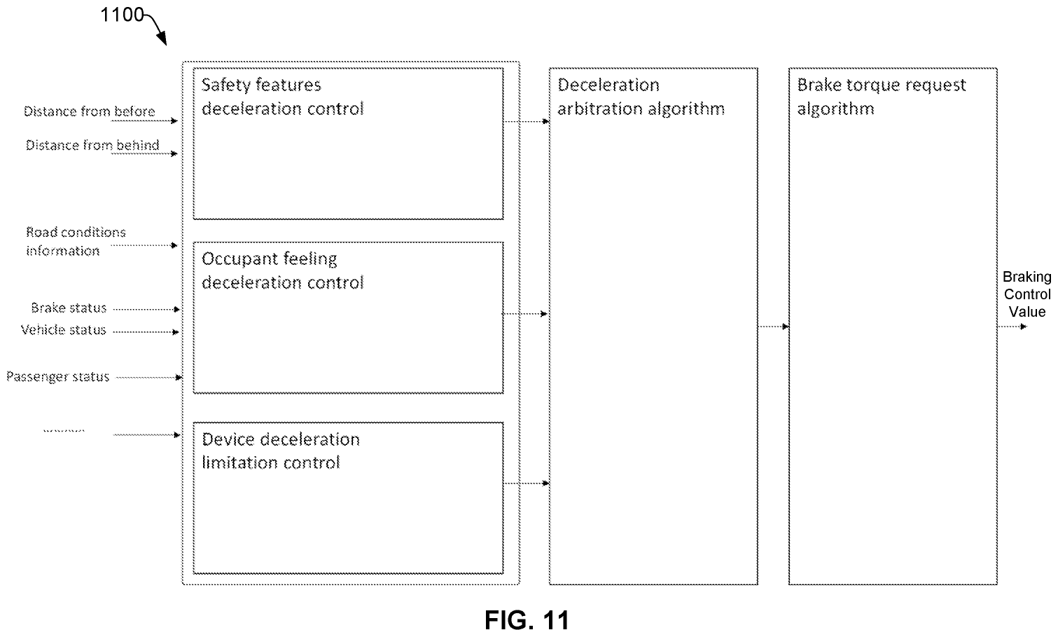

FIG. 11 illustrates an example schematics of an AEB control system 1100, in accordance with aspects of the present disclosure. As shown, the AEB control system 1100 includes various sub-control modules for receiving various sensor measurements. For example, the safety features deceleration control module receives a distance to an object in front of the ADV, and/or a distance from an object behind the ADV. The occupant feeling deceleration control module may receive road conditions information (e.g., inclination, which affects the pressure distribution to the car seat and the seatbelts, among other effects due to inclination of the ADV, such as braking). The occupant feeling deceleration control module may also receive feedback on the passenger status, such as seatbelt, seating position, and the age and other physical aspects of the occupants. The device deceleration limitation control module may receive brake status, road conditions, and vehicle status information to compute the upper and lower bounds of the rates of deceleration.

The various control modules may each determine a rate of deceleration based on the different input information, and provide the respective deceleration requests to the deceleration arbitration algorithm, which selects or arbitrates a final rate of deceleration. For example, a rate of deceleration based on occupant experience, as provided by the occupant feeling deceleration control module, may be lower than a rate of deceleration computed by the safety features deceleration control module. The deceleration arbitration algorithm resolves the potential conflicting deceleration requests using a weighted algorithm (see FIG. 12) or a machine learning model (see FIG. 13), to output a rate of deceleration that balances and considers the differences in the safety features control module, the occupant feeling deceleration module, and the device deceleration limitation control module.

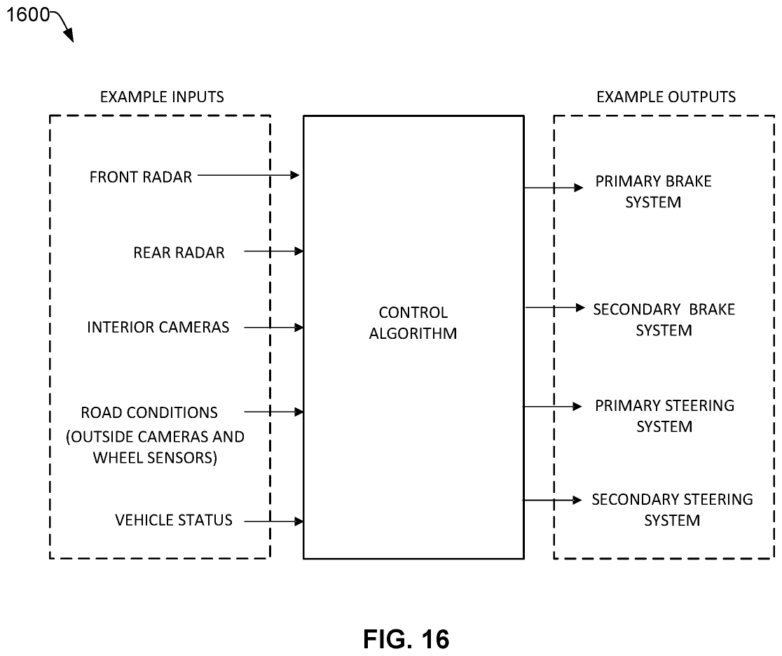

The brake torque request algorithm receives the output from the deceleration arbitration algorithm and computes a braking control value for the ADV's braking system to execute. In some cases, the deceleration arbitration algorithm may receive inputs similar to the example inputs to the control algorithm shown in FIG. 16. In some cases, the brake torque request algorithm may generate outputs similar to the example outputs by the control algorithm shown in FIG. 16. Although FIG. 11 illustrates the deceleration arbitration algorithm and the brake torque request algorithm as two separate control modules/algorithms, in some cases, they may be executed as one algorithm or control module, such as the control algorithm illustrated in FIG. 16 (or as the braking torque request algorithm illustrated in FIG. 12).

FIG. 12 illustrates an example algorithm 1200 with weight calibration for the AEB control system of FIG. 11, in accordance with aspects of the present disclosure. As shown, the example algorithm 1200 may be calibrated with various weighting factors w₁, w₂, . . . w₁₀₀, using lab or simulation data. The braking torque request algorithm computes a final deceleration request (DR) after applying the weighting factors to each of the inputs DR-1, DR-2, . . . , DR-100. Once calibrated, the weighting factors w₁, w₂, . . . w₁₀₀ may be applied to corresponding measurements in the same category (as shown in Table 2 above).

FIG. 13 illustrates an example algorithm 1300 using machine learning (or artificial intelligence (AI) model) for the AEB control system of FIG. 11, in accordance with aspects of the present disclosure. As shown, the algorithm 1300 may use a neural network (NN) to be trained to determine the final deceleration request based on multiple DR inputs. The NN may include multiple artificial neurons. An artificial neuron may receive signals (such as the cameras, infrared sensors, strain gauges, LIDAR, and other ADV sensors monitoring external and in cabin situations) then process the signals through layers of neurons connected therewith.

The signal at a connection (e.g., an edge) may include a number/value, and the output of each neuron may be computed by a non-linear function of the sum of the inputs. Neurons and edges typically have a weight that updates as learning proceeds: e.g., the weight may increase or decrease the strength of the signal at a connection. In some cases, the neurons may be aggregated into layers. Different layers may perform different transformations on the respective inputs. Signals may travel from the first layer (the input layer), to the last layer (the output layer), e.g., after traversing the layers multiple times.

The NN may be trained by processing examples, which may be collected from a lab or a simulation environment (e.g., based on occupant feedback as to feelings, experiences, or comfort levels with respect to various deceleration rates). The processing examples often include known input (specific rates of decelerations) and result (comfort level or ride experiences). The processing examples enable the NN to form probability-weighted associations between the input and result. As such, the NN may be trained to process the DR-1, DR-2, . . . , DR-100 without being programmed with specific rules. A trained NN (e.g., AI, or machine learning) model may output the final DR based on the DR-1, DR-2, . . . (see Table 2).

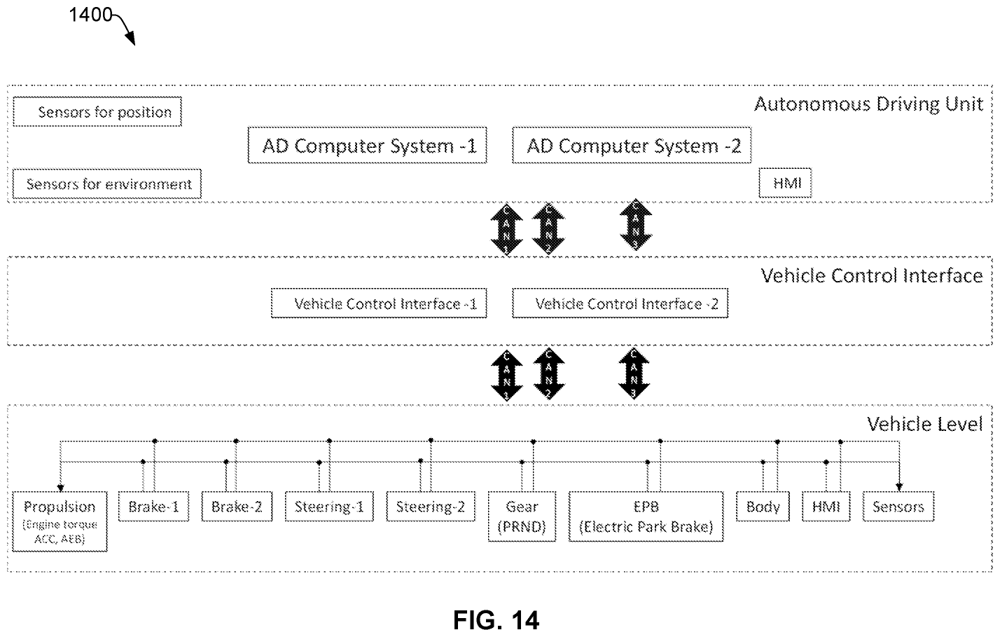

FIG. 14 is a block diagram 1400 of an example AEB control system, in accordance with aspects of the present disclosure. As shown, the example AEB control system may include three high-level components: the autonomous driving unit, the vehicle control interface, and the vehicle level components. The autonomous driving unit may include various sensors for the vehicle position and the environment, such as cameras and LIDAR systems. The autonomous driving unit may include one or more autonomous driving computer systems for computing control inputs to the vehicle level components (e.g., engine, braking system, steering, etc.).

The vehicle control interface allows of the sensor information be provided to the various vehicle level components. For example, a command/output from then AD computer system may be used to actuate two or more components (e.g., steering, and/or brake) at the vehicle level. According to aspects of the present disclosure, the rate of deceleration may be implemented by the braking system at the vehicle level.

In some cases, the braking system includes a primary braking system (PBS) and a secondary braking system (SBS) as a backup system for the primary braking system. For example, the ADV may decelerate using the PBS by implementing a brake torque request algorithm executing the rate of deceleration. In response to detecting a malfunction of the PBS, the ADV may decelerate using a secondary braking system (SBS) by implementing the brake torque request algorithm executing the rate of deceleration. The vehicle level components may include various sensors for providing feedback to the respective operations.

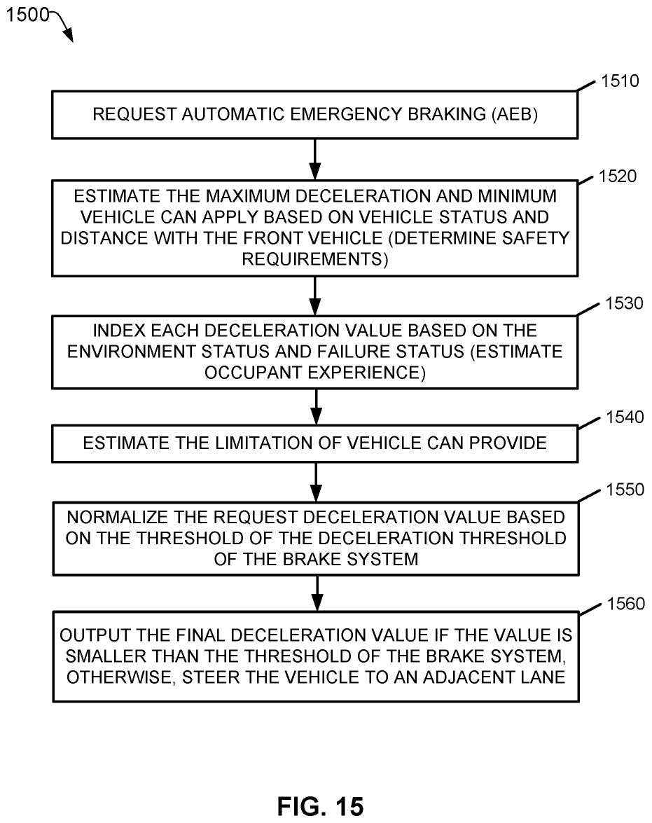

FIG. 15 a flow diagram 1500 illustrating a method of determining a final deceleration value based on occupant feelings, in accordance with aspects of the present disclosure. The method may be applicable to electric, hybrid, or internal combustion engine powered ADVs. The method may be performed by a processing logic (e.g., the controlling device 518 of FIG. 5), which may include software, hardware, or a combination thereof.

At operation 1510, the control module requests engagement of the AEB.

At operation 1520, the control module estimates the maximum deceleration and the minimum deceleration that the ADV may supply based on the ADV's status and distance to vehicles in the front and behind. The maximum and minimum rates of decelerations correspond to safety requirements to the ADV for avoiding collisions.

At operation 1530, the control module indexes each deceleration value based on the environment status and failure status (and estimates the occupant experience based on the decelerations).

At operation 1540, the control module estimates the limitation of the rate of deceleration that the ADV may provide.

At operation 1550, the control module normalizes the request deceleration value based on the threshold of the deceleration threshold of the braking system.

At operation 1560, the control module outputs the final deceleration value if the value is smaller than the threshold of the brake system. Otherwise, the control module steers the ADV to an adjacent lane (when the adjacent lane is not occupied).

FIG. 16 is a block diagram 1600 of an example control algorithm and the associated inputs and outputs, in accordance with aspects of the present disclosure. As shown, the control algorithm may use various measurements or sensors feedback as input. The example inputs include radar (or LIDAR) information of the front and rear of the ADV, imaging information from interior cameras, road conditions captured by exterior cameras and/or wheel sensors, and vehicle status (e.g., operation conditions of various systems, such as whether the primary braking system is operating properly).

Upon determining rates of deceleration and related braking parameters, the control algorithm may provide various example outputs to various systems of the ADV. For example, the example outputs may include control signals to the primary brake system, the secondary brake system (which may engage upon detecting malfunctioning of the primary brake system), the primary steering system (e.g., upon determining that an acceptable rate of deceleration cannot be achieved and that the ADV may safely change traveling lane to avoid collision), and the secondary steering system.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method for deceleration by a controlling device of an autonomous driving vehicle (ADV), the method comprising:
measuring, based on a current velocity of the ADV, a time to impact from an object in a course of a current trajectory of the ADV;
measuring a physical state of an occupant carried by the ADV;
computing, by a deceleration arbitration processing device, a rate of deceleration based on the time to impact and a physical change to the physical state of the occupant to be caused by the rate of deceleration; and
decelerating the ADV at the rate of deceleration.

2. The method of claim 1, wherein computing the rate of deceleration comprises:
comparing the rate of deceleration with a control limit; and
in response to the rate of deceleration exceeding the control limit, update the rate of deceleration to a limited rate of deceleration.

3. The method of claim 2, wherein the control limit comprises:
an upper bound of value corresponding to a maximal magnitude of deceleration generated by a braking system of the ADV, wherein the braking system comprises a contact surface engaging the current trajectory and a braking mechanism converting a kinetic energy of the ADV into a non-kinetic energy of the ADV, wherein the non-kinetic energy comprises at least one of: a thermal energy or an electric energy.

4. The method of claim 1, wherein computing the rate of deceleration based on the time to impact and the physical change to the physical state of the occupant comprises:
minimizing a peak physical stress of the physical change associated with the rate of deceleration, wherein the peak physical stress is modeled based on a constraint condition of the occupant.

5. The method of claim 4, further comprising:
monitoring, with at least an optical sensor, an infrared sensor, or a strain sensor, the constraint condition of the occupant, wherein:
the optical sensor monitors a seatbelt condition and a seating position of the occupant,
the infrared sensor monitors, via temperature information, the seatbelt condition, and the seating position of the occupant, and
the strain sensor measures a stress level of the seatbelt condition; and
determining an estimate of a body mass of the occupant via the optical sensor, the seatbelt condition, or both.

6. The method of claim 5, further comprising:
comparing a peak physical stress to a comfort stress value associated with the body mass and seatbelt condition of the occupant; and
in response to the peak physical stress exceeding the comfort stress value, reducing the rate of deceleration to reduce the peak physical stress to the comfort stress value.

7. The method of claim 6, further comprising:
determining that the reduced rate of deceleration does not provide a safe operation of the ADV in the current trajectory; and
identify an alternative trajectory of safe operation that provides the reduced rate of deceleration.

8. The method of claim 7, wherein the alternative trajectory of safe operation comprises a different traveling lane adjacent to the current trajectory.

9. The method of claim 1, wherein decelerating the ADV at the rate of deceleration comprises:
decelerating the ADV using a primary braking system (PBS) by implementing a brake torque request algorithm executing the rate of deceleration; and
in response to detecting a malfunction of the PBS, decelerating the ADV using a secondary braking system (SBS) by implementing the brake torque request algorithm executing the rate of deceleration.

10. The method of claim 1, wherein computing, by the deceleration arbitration processing device, the rate of deceleration comprises:
training a machine learning model at the deceleration arbitration processing device with experimental and simulation data of occupant feedback and physical stress measurements to predict a relationship between the rate of deceleration and one or more of: seating configuration, seatbelt configuration, body mass of the occupant, and a comfort stress range indicated by the occupant feedback.

11. A data processing system of an autonomous driving vehicle (ADV), comprising:
a processor; and
a memory coupled to the processor to store instructions, which when executed by the processor, cause the processor to perform operations, the operations including:
measuring, based on a current velocity of the ADV, a time to impact from an object in a course of a current trajectory of the ADV;
measuring a physical state of an occupant carried by the ADV;
computing, by a deceleration arbitration processing device, a rate of deceleration based on the time to impact and a physical change to the physical state of the occupant to be caused by the rate of deceleration; and
decelerating the ADV at the rate of deceleration.

12. The data processing system of claim 11, wherein the operations of computing the rate of deceleration comprises:
comparing the rate of deceleration with a control limit; and
in response to the rate of deceleration exceeding the control limit, update the rate of deceleration to a limited rate of deceleration.

13. The data processing system of claim 12, wherein the control limit comprises:
an upper bound of value corresponding to a maximal magnitude of deceleration generated by a braking system of the ADV, wherein the braking system comprises a contact surface engaging the current trajectory and a braking mechanism converting a kinetic energy of the ADV into a non-kinetic energy of the ADV, wherein the non-kinetic energy comprises at least one of: a thermal energy or an electric energy.

14. The data processing system of claim 11, wherein the operations of computing the rate of deceleration based on the time to impact and the physical change to the physical state of the occupant comprise:
minimizing a peak physical stress of the physical change associated with the rate of deceleration, wherein the peak physical stress is modeled based on a constraint condition of the occupant.

15. The data processing system of claim 14, wherein the operations further comprise:
monitoring, with at least an optical sensor, an infrared sensor, or a strain sensor, the constraint condition of the occupant, wherein:
the optical sensor monitors a seatbelt condition and a seating position of the occupant,
the infrared sensor monitors, via temperature information, the seatbelt condition, and the seating position of the occupant, and
the strain sensor measures a stress level of the seatbelt condition; and
determining an estimate of a body mass of the occupant via the optical sensor, the seatbelt condition, or both.

16. The data processing system of claim 15, wherein the operations further comprise:
comparing a peak physical stress to a comfort stress value associated with the body mass and seatbelt condition of the occupant; and
in response to the peak physical stress exceeding the comfort stress value, reducing the rate of deceleration to reduce the peak physical stress to the comfort stress value.

17. The data processing system of claim 16, wherein the operations further comprise:
determining that the reduced rate of deceleration does not provide a safe operation of the ADV in the current trajectory; and
identify an alternative trajectory of safe operation that provides the reduced rate of deceleration.

18. The data processing system of claim 17, wherein the alternative trajectory of safe operation comprises a different traveling lane adjacent to the current trajectory.

19. The data processing system of claim 11, wherein the operations of decelerating the ADV at the rate of deceleration comprise:
decelerating the ADV using a primary braking system (PBS) by implementing a brake torque request algorithm executing the rate of deceleration; and
in response to detecting a malfunction of the PBS, decelerating the ADV using a secondary braking system (SBS) by implementing the brake torque request algorithm executing the rate of deceleration.

20. A non-transitory machine-readable medium having instructions stored therein, which when executed by a processor, cause the processor to perform operations, the operations comprising:
measuring, based on a current velocity of an autonomous driving vehicle (ADV), a time to impact from an object in a course of a current trajectory of the ADV;
measuring a physical state of an occupant carried by the ADV;
computing, by a deceleration arbitration processing device, a rate of deceleration based on the time to impact and a physical change to the physical state of the occupant to be caused by the rate of deceleration; and
decelerating the ADV at the rate of deceleration.
